(19) United States
(12) Patent Application Publication
(10) Pub. No.: US 2024/0311536 A1
(43) Pub. Date: Sep. 19, 2024

(54) MULTI-FIELD COUPLED LB SIMULATION METHOD AND SYSTEM FOR HEAT AND MASS TRANSFER FLOW, AND STORAGE MEDIUM

(71) Applicants: CHONGQING XIKE CONSULTING CO.,LTD FOR WATER TRANSPORT ENGINEERING, Chongqing City (CN); CHONGQING JIAOTONG UNIVERSITY, Chongqing City (CN)

(72) Inventors: Wei DIAO, Chongqing City (CN); Peiyi PENG, Chongqing City (CN); Hao YUAN, Chongqing City (CN); Dewei MU, Chongqing City (CN); Chunze ZHANG, Chongqing City (CN); Qihang XU, Chongqing City (CN); Chunhang XIE, Chongqing City (CN)

(73) Assignees: CHONGQING XIKE CONSULTING CO.,LTD FOR WATER TRANSPORT ENGINEERING, Chongqing City (CN); CHONGQING JIAOTONG UNIVERSITY, Chongqing City (CN)

(21) Appl. No.: 18/433,476

(22) Filed: Feb. 6, 2024

(30) Foreign Application Priority Data
Mar. 15, 2023 (CN) 2023102522448

(51) Int. Cl. G06F 30/28

(52) U.S. Cl. CPC G06F 30/28

(57) ABSTRACT

The invention discloses a multi-field coupled Lattice Boltzmann (LB) simulation method and system designed for heat and mass transfer flow, along with a storage medium. Initial parameters of a target water body are acquired and imported into a pre-set multi-field coupled LB model for heat and mass transfer flow simulation. This process yields flow velocity distribution, temperature distribution, and pollutant concentration distribution information, facilitating the accurate depiction of a three-dimensional spatial distribution map of the flow field, temperature field, and concentration field of the target water body. Through the integration of a total energy distribution LB model and a passive scalar model via a force term, bidirectional coupling of the flow field, temperature field, and concentration field is achieved. This establishes a multi-field coupled LB model capable of accurately simulating water temperature and quality, surpassing conventional methods in water temperature simulation accuracy.

### TECHNICAL FIELD

The present invention relates to the technical field of fluid simulation, and in particular to a multi-field coupled Lattice Boltzmann (LB) simulation method and system for heat and mass transfer flow, and a storage medium.

### BACKGROUND ART

In large reservoirs, the convective effect of water flow affects the distribution of temperature and concentration. On the other hand, the uneven distribution of temperature and concentration will make the density difference of the water body and then form the bulk force to drive the water flow. Therefore, to realize the heat and mass transfer flow simulation of the reservoir, it is necessary to establish a model that can simulate the flow field, temperature field, and concentration field in the reservoir at the same time, and consider the coupling effect between the various fields.

The simulation of heat and mass transfer flow has been a hot topic in the LB method since 1993, many scholars have been exploring heat and mass transfer models based on the LB method, and the most mature models are the multi-velocity model and multi-distribution function model. Based on the constant temperature LB model, the multi-velocity model is constructed by introducing a new discrete velocity. In this model, the particles are moved to a more distant grid to count several macroscopic physical quantities such as density, velocity, and temperature. This model is a generalization of the constant temperature LB model, and it is consistent with it, for example, the macroscopic quantities in the model are still obtained by summing the velocity moments of each order of the distribution function. However, the multi-velocity model constructs a more complex discrete velocity and compound lattice to restore the temperature macro-evolution equation, which has the disadvantage of being unable to adjust the Prandtl number and poor numerical stability, which limits the development of the model.

The multi-distribution function model uses multiple sets of distribution functions to define and process the flow motion equation, energy equation, and convective diffusion equation. Each distribution function simulates a physical field and then applies it to the simulation of the velocity field, temperature field, and concentration field. Compared with the multi-velocity model, the multi-field coupling model has a clearer physical meaning and simpler algorithm structure. The Prandtl number is adjustable and has higher numerical stability, which can effectively simulate physical problems with a wide range of temperature or concentration changes. However, the disadvantage of this model is that the flow equation of state is independent of temperature and concentration, and the pressure caused by temperature difference and concentration difference cannot be directly fed back into the velocity field, so it is mainly used in the flow simulation with low Mach number and small temperature/concentration gradient. Currently, the flow field heat transfer coupling model or the flow field mass transfer coupling model has also been studied accordingly, but the perfect research application on the coupling of the numerical model and the reservoir heat and mass transfer flow field based on the LB method has not yet been seen.

### SUMMARY

An object of the present invention is to provide a multi-field coupled LB simulation method and system for heat and mass transfer flow, and a storage medium to solve the above-mentioned problems in the prior art.

To achieve the above object, the present invention adopts the following technical solutions:

In a first aspect, there is provided a multi-field coupled LB simulation method for heat and mass transfer flow, including:
acquiring initial parameters for a target water body;
importing the initial parameters into a pre-set multi-field coupled LB model of heat and mass transfer flow to perform a simulation operation to obtain flow velocity distribution information, temperature distribution information, and pollutant concentration distribution information about the target water body, where the multi-field coupled LB model is obtained by combining a total energy distribution LB model with a passive scalar model by an introduced set force term to realize bidirectional coupling of a flow field, a temperature field, and a concentration field; and
obtaining, according to the flow velocity distribution information, the temperature distribution information, and the pollutant concentration distribution information, spatial distribution results of a flow field, temperature field, and concentration field of the target water body.

In one possible design, the multi-field coupled LB model is

$${f}_{i} ( x + c {δ}_{t} , t + {δ}_{t} ) = {f}_{i} ( x , t ) - \frac{1}{{τ}_{e}} [ {f}_{i} ( x , t ) - {f}_{i}^{eq} ( ρ , u ) ] + {δ}_{i} {F}_{i} ( i = 0 , 1 , … 18 ) , \\ {g}_{i} ( x + c {δ}_{t} , t + {δ}_{t} ) - {g}_{i} ( x , t ) = - \frac{1}{{τ}_{γ}} [ {g}_{i} ( x , t ) - {g}_{i}^{( eq )} ( x , t ) ] ( i = 1 , 2 , … 6 ) , \\ {h}_{i} ( x + c {δ}_{t} , t + {δ}_{t} ) - {h}_{i} ( x , t ) = - \frac{1}{{τ}_{C}} [ {h}_{i} ( x , t ) - {h}_{i}^{( eq )} ( x , t ) ] ( i = 1 , 2 , … 6 ) , \\ {F}_{i} = \frac{1}{2} ( {j}_{i} ( x , t ) + {j}_{i} ( x + {e}_{i} {δ}_{t} , i + {δ}_{t} ) ) , \\ {j}_{t} = {ω}_{i} \{ A - 3 B \cdot [ ( {e}_{t} - u ) + 3 ( {e}_{i} \cdot u ) {e}_{i} ] \} , \\ {f}_{i}^{( eq )} = {ω}_{i} ρ [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] , \\ {g}_{i}^{( eq )} = {ω}_{i} {p}_{α} [ \frac{{c}_{i} \cdot u}{{c}_{s}^{2}} + \frac{{( {c}_{i} \cdot u )}^{2}}{2 {c}_{s}^{4}} - \frac{{u}^{2}}{{c}_{s}^{2}} + \frac{1}{2} ( \frac{{c}_{i}}{{c}_{s}^{2}} - D ) ] + {Ef}_{i}^{( eq )} , \\ {h}_{i}^{( eq )} = {ω}_{i} C [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] ,$$

where f represents a flow velocity distribution function; g represents a temperature distribution function obtained according to a total energy distribution LB model; h represents a concentration distribution function obtained according to a passive scalar model; F represents a force term function; i represents a direction parameter; f^{(eq)} represents a flow velocity equilibrium distribution function; g^{(eq)} represents a temperature equilibrium distribution function; h^{(eq)} represents a concentration equilibrium distribution function; x represents a vector position parameter; c represents a unit velocity parameter; cₛ represents a lattice velocity; δₜ represents a unit time parameter; t is a time parameter; u represents a water flow velocity parameter; ω represents a calculation weight coefficient; τ represents a relaxation time parameter; e represents a format velocity parameter; ρ represents a water body density parameter; p represents a pressure parameter; A represents a source term or a sink term in a continuous equation; B represents a source term or a sink term in a momentum equation; for the heat and mass transfer flow characteristics of a reservoir, setting A=0, B=−g[β_{T}(T−T₀)+β_{C}(C−C₀)], β_{C} represents a thermal expansion coefficient; β_{T} represents a solute volume expansion coefficient; C represents a pollution concentration; C₀ represents a reference concentration; D represents a spatial dimension; E represents a set total energy; T represents a water body temperature; T₀ represents a reference temperature.

In one possible design, the initial parameters include the vector position parameter, the unit velocity parameter, the unit time parameter, the water flow velocity parameter, the calculation weight coefficient, the relaxation time parameter, the format velocity parameter, the water body density parameter, the pressure parameter, the thermal expansion coefficient, the solute volume expansion coefficient, the pollution concentration, the reference concentration, the water body temperature, and the reference temperature.

In one possible design, the obtaining, according to the flow velocity distribution information, the temperature distribution information, and the pollutant concentration distribution information, spatial distribution results of a flow field, temperature field, and concentration field of the target water body includes constructing, according to the flow velocity distribution information, the temperature distribution information, and the pollutant concentration distribution information, a three-dimensional spatial distribution map of the flow field, the temperature field, and the concentration field of the target water body.

In one possible design, the constructing, according to the flow velocity distribution information, the temperature distribution information, and the pollutant concentration distribution information, a three-dimensional spatial distribution map of the flow field, the temperature field, and the concentration field of the target water body includes: importing the flow velocity distribution information, the temperature distribution information, and the pollutant concentration distribution information into a preset Tecplot software to construct the three-dimensional spatial distribution map of the flow field, the temperature field, and the concentration field of the target water body.

In one possible design, the method further includes: acquiring a construction instruction, constructing the multi-field coupled LB model of heat and mass transfer flow according to the construction instruction, and pre-storing the multi-field coupled LB model.

In a second aspect, there is provided a multi-field coupled LB simulation system for heat and mass transfer flow, including an acquisition unit, a simulation unit, and an output unit.

The acquisition unit is configured to acquire initial parameters for a target water body.

The simulation unit is configured to import the initial parameters into a pre-set multi-field coupled LB model of heat and mass transfer flow to perform a simulation operation to obtain flow velocity distribution information, temperature distribution information, and pollutant concentration distribution information about the target water body; the multi-field coupled LB model is obtained by combining a total energy distribution LB model with a passive scalar model by an introduced set force term to realize bidirectional coupling of a flow field, a temperature field, and a concentration field.

The output unit is configured to obtain, according to the flow velocity distribution information, the temperature distribution information, and the pollutant concentration distribution information, spatial distribution results of a flow field, temperature field, and concentration field of the target water body.

In one possible design, the system further includes a construction unit; the construction unit is configured to acquire a construction instruction, construct the multi-field coupled LB model of heat and mass transfer flow according to the construction instruction, and pre-store the multi-field coupled LB model.

In a third aspect, there is provided a multi-field coupled LB simulation system for heat and mass transfer flow, including:
a memory, configured to store instructions; and
a processor, configured to read instructions stored in the memory and perform the method according to any one of the first aspects according to the instructions.

In a fourth aspect, there is provided a computer-readable storage medium storing thereon instructions, the instructions, when executed on a computer, causing the computer to perform the method according to any one of the first aspects. There is further provided a computer program product including instructions, the instructions, when executed on a computer, causing the computer to perform the method according to any one of the first aspects.

Beneficial effects: In the present invention, initial parameters for a target water body are acquired, and the initial parameters are imported into a pre-set multi-field coupled LB model of heat and mass transfer flow to perform a simulation operation to obtain flow velocity distribution information, temperature distribution information, and pollutant concentration distribution information about the target water body, to accurately depict and output a three-dimensional spatial distribution map of a flow field, a temperature field, and a concentration field of the target water body. A total energy distribution LB model and a passive scalar model are combined by introducing a force term; the flow velocity participates in the calculation of the temperature and concentration, and the concentration and temperature can calculate the force and react to the flow field, thereby realizing the bidirectional coupling of the flow field, the temperature field, and the concentration field; a multi-field coupled LB model for simulating the heat and mass transfer flow of the water body is established, which can simultaneously simulate the water temperature and water quality concerning the existing model, and the simulation of the water temperature is more accurate than the existing common methods.

### BRIEF DESCRIPTION OF THE DRAWINGS

To explain the examples of the present disclosure or the technical solutions in the prior art more clearly, a brief introduction will be made to the accompanying drawings used in the examples or the description of the prior art. It is obvious that the drawings in the description below are only some examples of the present disclosure, and those ordinarily skilled in the art can obtain other drawings according to these drawings without creative work.

FIG. 1 is a diagram of steps of a method according to an example of the present invention;

FIG. 2 is a diagram of a model reservoir according to an example of the present invention;

FIG. 3 is a diagram of a simulated flow field and temperature field for 50 s according to an example of the present invention;

FIG. 4 is a composition diagram of a system according to an example of the present invention.

### DETAILED DESCRIPTION OF THE EMBODIMENTS

It is to be understood that the description of these examples is intended to aid in the understanding of the present invention, and is not intended to limit the scope of the present invention. The specific structural and functional details disclosed herein are merely illustrative of exemplary examples of the present invention. This invention may, however, be embodied in many alternative forms and should not be construed as limited to the examples set forth herein.

It is to be understood that, unless expressly specified and limited otherwise, the term “connected” is to be interpreted broadly, e.g. either fixedly or detachably, or integrally; maybe a mechanical connection or an electrical connection; it can be directly connected or indirectly connected through an intermediate medium, and can be the communication between two elements. The specific meaning of the above terms in the examples can be understood by those of ordinary skill in the art according to specific circumstances.

In the following description, specific details are provided to facilitate a thorough understanding of example examples. However, it will be understood by one of ordinary skill in the art that the example examples may be practiced without these specific details. For example, systems may be shown in block diagrams in order not to obscure the examples in unnecessary detail. In other instances, well-known processes, structures, and techniques may not be shown in unnecessary detail to avoid obscuring the examples.

### Example 1

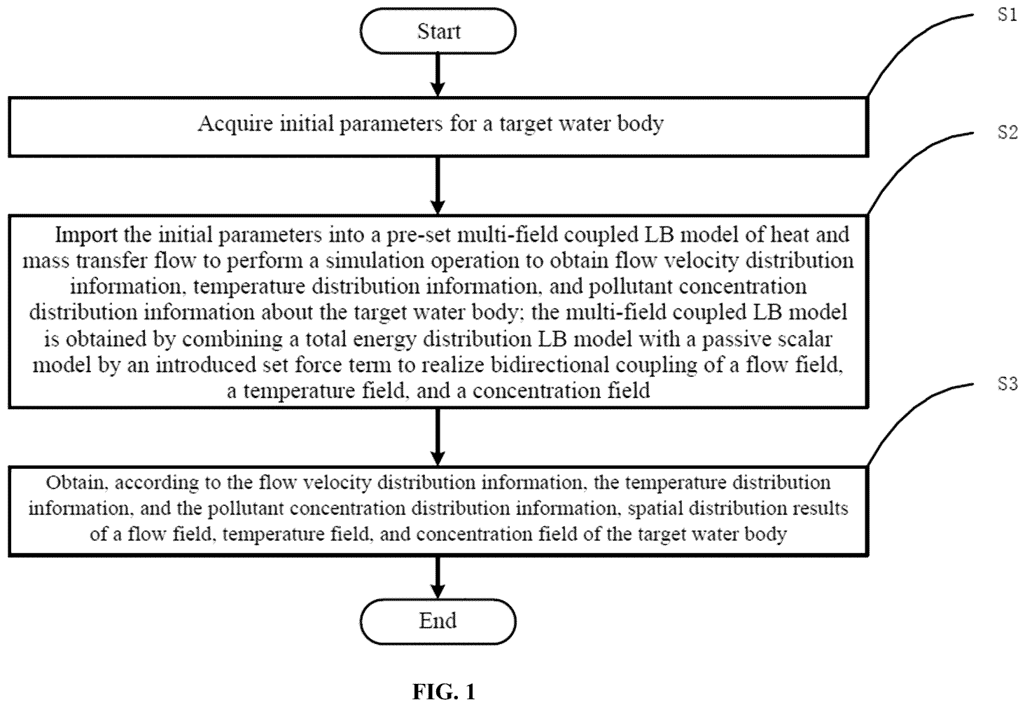

The example provides a multi-field coupled LB simulation method for heat and mass transfer flow; as shown in FIG. 1, the method includes the following steps:

S1: Acquire initial parameters for a target water body.

In a specific implementation, before performing simulation, it is necessary to first obtain initial parameters for a target water body, and the initial parameters may include a vector position parameter, a unit velocity parameter, a unit time parameter, a water flow velocity parameter, a calculation weight coefficient, a relaxation time parameter, a format velocity parameter, a water body density parameter, a pressure parameter, a thermal expansion coefficient, a solute contaminant concentration coefficient, a reference concentration, a water body temperature, and a reference temperature.

S2: Import the initial parameters into a pre-set multi-field coupled LB model of heat and mass transfer flow to perform a simulation operation to obtain flow velocity distribution information, temperature distribution information, and pollutant concentration distribution information about the target water body, where the multi-field coupled LB model is obtained by combining a total energy distribution LB model with a passive scalar model by an introduced set force term to realize bidirectional coupling of a flow field, a temperature field, and a concentration field.

In specific implementation, after obtaining the initial parameters, the initial parameters are imported into a pre-set multi-field coupled LB model of heat and mass transfer flow to perform simulation calculation, to obtain flow velocity distribution information, temperature distribution information, and pollutant concentration distribution information about the target water body; the multi-field coupled LB model combines the total energy distribution LB model and the passive scalar model by introducing a set force term for realizing bidirectional coupling of the flow field, the temperature field, and the concentration field. The construction process of the multi-field coupled LB model includes: acquiring a construction instruction, constructing the multi-field coupled LB model of heat and mass transfer flow according to the construction instruction, and pre-storing the multi-field coupled LB model. The multi-field coupled LB model is:

$${f}_{i} ( x + c {δ}_{t} , t + {δ}_{t} ) = {f}_{i} ( x , t ) - \frac{1}{τ} [ {f}_{i} ( x , t ) - {f}_{i}^{eq} ( ρ , u ) ] + {δ}_{t} {F}_{i} ( i = 0 , 1 , … 18 ) , \\ {g}_{i} ( x + c {δ}_{t} , t + {δ}_{t} ) - {g}_{i} ( x , t ) = - \frac{1}{{τ}_{γ}} [ {g}_{i} ( x , t ) - {g}_{i}^{( eq )} ( x , t ) ] ( i = 1 , 2 , … 6 ) , \\ {h}_{i} ( x + c {δ}_{t} , t + {δ}_{t} ) - {h}_{i} ( x , t ) = - \frac{1}{{τ}_{C}} [ {h}_{i} ( x , t ) - {h}_{i}^{( eq )} ( x , t ) ] ( i = 1 , 2 , … 6 ) , \\ {F}_{i} = \frac{1}{2} ( {j}_{i} ( x , t ) + {j}_{i} ( x + {e}_{i} {δ}_{t} , i + {δ}_{t} ) ) , \\ {j}_{i} = {ω}_{i} \{ A - 3 B \cdot [ ( {e}_{i} - u ) + 3 ( {e}_{i} \cdot u ) {e}_{i} ] \} ,$$

where f represents a flow velocity distribution function; g represents a temperature distribution function obtained according to a total energy distribution LB model; h represents a concentration distribution function obtained according to a passive scalar model; F represents a force term function; i represents a direction parameter; f^{(eq)} represents a flow velocity equilibrium distribution function; g^{(eq)} represents a temperature equilibrium distribution function; h^{(eq)} represents a concentration equilibrium distribution function; x represents a vector position parameter; c represents a unit velocity parameter; cₛ represents a lattice velocity; βₜ represents a unit time parameter; t is a time parameter; u represents a water flow velocity parameter; ω represents a calculation weight coefficient; τ represents a relaxation time parameter; e represents a format velocity parameter; ρ represents a water body density parameter; p represents a pressure parameter; A represents a source term or a sink term in a continuous equation; B represents a source term or a sink term in a momentum equation; for the heat and mass transfer flow characteristics of a reservoir, setting A=0, B=−g[β_{T}(T−T₀)+β_{C}(C−C₀)], β_{c} represents a thermal expansion coefficient; Br represents a solute volume expansion coefficient; C represents a pollution concentration; C₀ represents a reference concentration; T represents a water body temperature; To represents a reference temperature.

On the other hand, the change in the temperature field and concentration field, and the equilibrium state of each physical field are influenced by the velocity of the flow field.

The distribution functions share a set of flow rates, which are expressed as follows:

$${f}_{i}^{( eq )} = {ω}_{i} ρ [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] , \\ {g}_{i}^{( eq )} = {ω}_{i} {p}_{α} [ \frac{{c}_{i} \cdot u}{{c}_{s}^{2}} + \frac{{( {c}_{i} \cdot u )}^{2}}{2 {c}_{s}^{4}} - \frac{{u}^{2}}{{c}_{s}^{2}} + \frac{1}{2} ( \frac{{c}_{i}}{{c}_{s}^{2}} - D ) ] + {Ef}_{i}^{( eq )} , \\ {h}_{i}^{( eq )} = {ω}_{i} C [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] .$$

The statistical calculation of the corresponding macroscopic quantity is ρ=Σfᵢ, pu=>Σcᵢfᵢ+ρaδₜ/2, ρT=Σgᵢ+ρu·aδₜ/2, C=Σhᵢ; D characterizes the spatial dimension, E characterizes the set total energy if the multi-component pollution quality needs to be considered in the simulation, the above formula can be directly extended to multiple equations. The flow velocity distribution information, temperature distribution information, and pollutant concentration distribution information based on time and space are obtained after the initial parameters are imported into the multi-field coupled LB model for simulation.

S3: Obtain, according to the flow velocity distribution information, the temperature distribution information, and the pollutant concentration distribution information, spatial distribution results of a flow field, temperature field, and concentration field of the target water body.

In the specific implementation, after obtaining the flow velocity distribution information, temperature distribution information, and pollutant concentration distribution information, the flow velocity distribution information, temperature distribution information and pollutant concentration distribution information can be imported into the preset Tecplot software to construct the three-dimensional spatial distribution map of the target water body flow field, temperature field, and concentration field as the spatial distribution result for output, to realize the accurate characterization of the target water body flow field, temperature field and concentration field.

Concerning the above-mentioned method, the present example provides a specific application example:

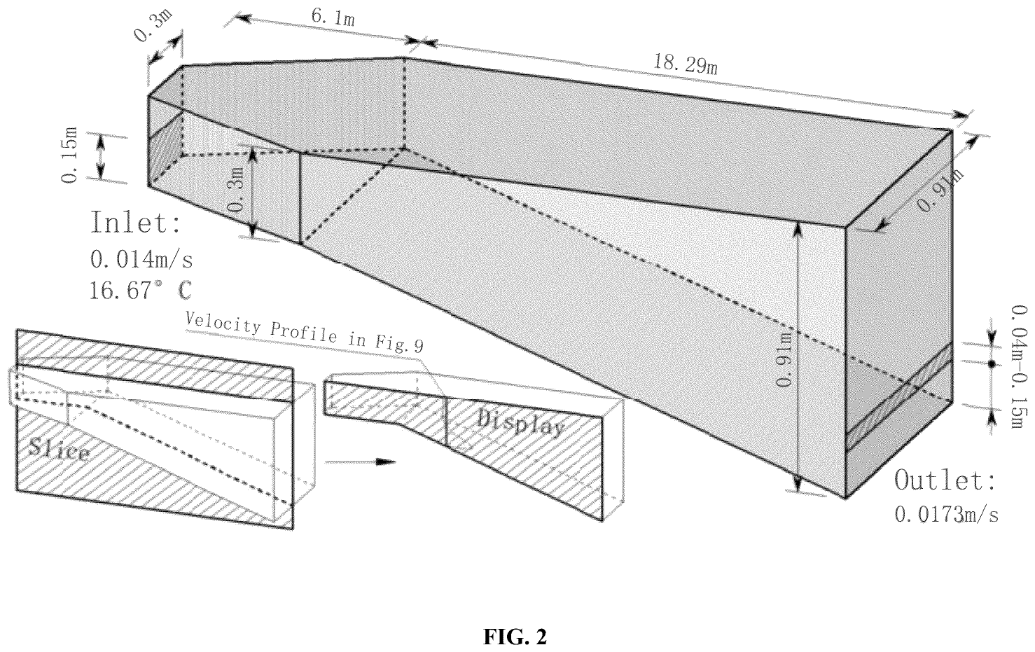

Taking the model reservoir of a waterway test station as an example, the evolution process of its flow field and temperature field with time and space is simulated by this simulation method. The model reservoir is shown in FIG. 2, with the front section of the reservoir being 6.1 m long, 0.3 m high, and its width varying linearly from 0.3 m to 0.91 m, and the back section of the reservoir being 18.29 m long, 0.91 m wide, and its height varying from 0.3 m to 0.91 m. The inlet is an orifice with a height of 0.15 m near the bottom of the left wall and the outlet is a narrow 0.04 m high at 0.15 m above the bottom. The water temperature in the model reservoir is 21.44° C. uniformly distributed in the initial state, and the cold water with a flow rate of 0.00063 m3/s and a temperature of 16.67° C. is poured from the inlet after the simulation.

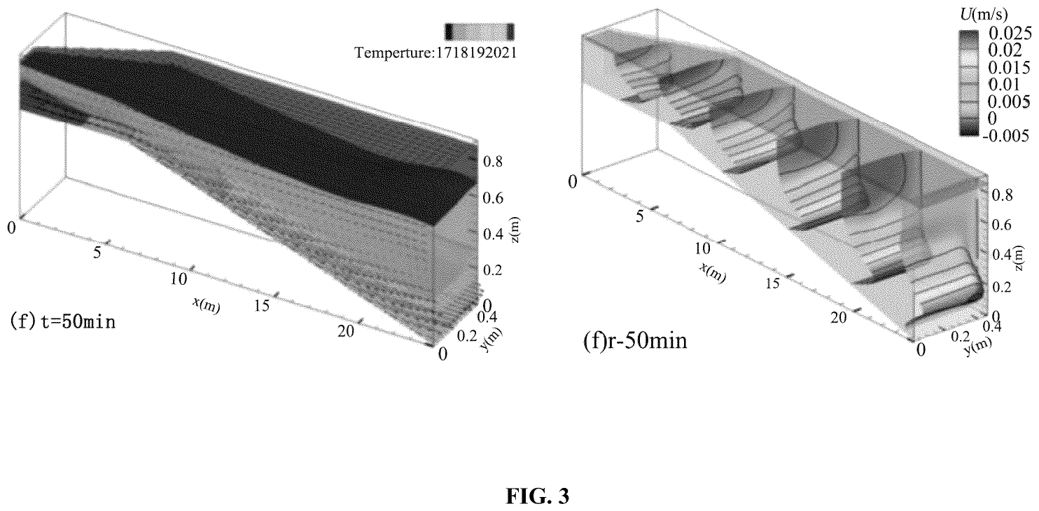

The corresponding computational grid uses 2440×46×92 (scale Δx=Δy=Δz=0.01 m). The symmetry boundary adopted by the reservoir symmetry plane; after dividing the inflow into the inlet area, set the inlet flow rate as 0.014 m/s; the outlet is a velocity boundary of 0.0173 m/s; the rest are solid walls. In the simulation of the temperature field, the inlet water flow is set to a constant temperature of 16.67° C., and the other walls are adiabatic boundary conditions. For the boundary conditions, the heuristic scheme is adopted for the symmetric boundary and the fixed wall boundary, and the non-equilibrium extrapolation scheme is adopted for the reservoir entrance and exit boundaries. By inputting the above parameters and initial conditions into the multi-field coupled LB model of heat and mass transfer flow and post-processing the output results, the flow field and temperature field of the reservoir at any time can be obtained, as shown in FIG. 3, which is a schematic diagram of 50 min of the simulated flow field and temperature field.

### Example 2

The example provides a multi-field coupled LB simulation system for heat and mass transfer flow, including an acquisition unit, a simulation unit, and an output unit.

The acquisition unit is configured to acquire initial parameters for a target water body.

The simulation unit is configured to import the initial parameters into a pre-set multi-field coupled LB model of heat and mass transfer flow to perform a simulation operation to obtain flow velocity distribution information, temperature distribution information, and pollutant concentration distribution information about the target water body; the multi-field coupled LB model is obtained by combining a total energy distribution LB model with a passive scalar model by an introduced set force term to realize bidirectional coupling of a flow field, a temperature field, and a concentration field.

The output unit is configured to obtain, according to the flow velocity distribution information, the temperature distribution information, and the pollutant concentration distribution information, spatial distribution results of a flow field, temperature field, and concentration field of the target water body.

Further, the system includes a construction unit; the construction unit is configured to acquire a construction instruction, construct the multi-field coupled LB model of heat and mass transfer flow according to the construction instruction, and pre-store the multi-field coupled LB model.

### Example 3

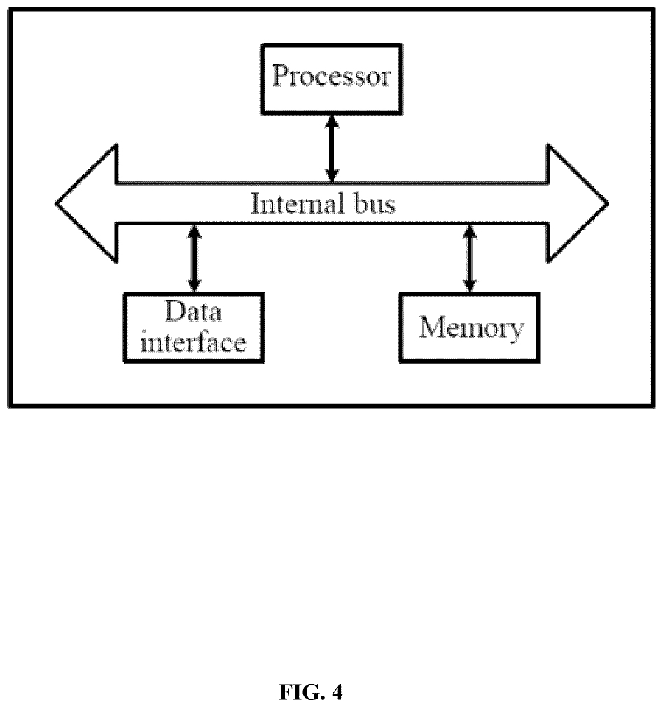

The example provides a multi-field coupled LB simulation system for heat and mass transfer flow, as shown in FIG. 4, including the following at the hardware level.

A data interface is configured to establish data docking between the processor and the data source end.

A memory is configured to store instructions.

A processor is configured to read instructions stored in the memory and perform the multi-field coupled LB simulation method for heat and mass transfer flow in Example 1 according to the instructions: S1, acquiring initial parameters for a target water body; S2, importing the initial parameters into a pre-set multi-field coupled LB model of heat and mass transfer flow to perform a simulation operation to obtain flow velocity distribution information, temperature distribution information, and pollutant concentration distribution information about the target water body, where the multi-field coupled LB model is obtained by combining a total energy distribution LB model with a passive scalar model by an introduced set force term to realize bidirectional coupling of a flow field, a temperature field, and a concentration field; and S3, obtaining, according to the flow velocity distribution information, the temperature distribution information, and the pollutant concentration distribution information, spatial distribution results of a flow field, temperature field, and concentration field of the target water body.

Optionally, the device further includes an internal bus. The processor and memory and data interfaces may be interconnected by an internal bus, which may be an industry standard architecture (ISA) bus, a peripheral component interconnect (PCI) bus, or an extended industry standard architecture (EISA) bus. The bus may be divided into an address bus, a data bus, a control bus, and the like.

The memory may include, but is not limited to, random access memory (RAM), read-only memory (ROM), flash memory, first input first output (FIFO), and/or first in last out (FILO), and the like. The processor may be a general-purpose processor, including a central processing unit (CPU), a network processor (NP), and the like; they may also be digital signal processors (DSP), application-specific integrated circuit (ASIC), field-programmable gate arrays (FPGA), or other programmable logic devices, discrete gate, or transistor logic devices, discrete hardware components.

### Example 4

The example provides a computer-readable storage medium storing thereon instructions, the instructions, when executed on a computer, causing the computer to perform the multi-field coupled LB simulation method for heat and mass transfer flow in Example 1: S1, acquiring initial parameters for a target water body; S2, importing the initial parameters into a pre-set multi-field coupled LB model of heat and mass transfer flow to perform a simulation operation to obtain flow velocity distribution information, temperature distribution information, and pollutant concentration distribution information about the target water body, where the multi-field coupled LB model is obtained by combining a total energy distribution LB model with a passive scalar model by an introduced set force term to realize bidirectional coupling of a flow field, a temperature field, and a concentration field; and S3, obtaining, according to the flow velocity distribution information, the temperature distribution information, and the pollutant concentration distribution information, spatial distribution results of a flow field, temperature field, and concentration field of the target water body. The computer-readable storage medium refers to the carrier for storing data, which may, but is not limited to, include floppy disk, optical disk, hard disk, flash memory, flash drive, and/or memory stick. The computer may be a general-purpose computer, special-purpose computer, computer network, or other programmable system.

The example also provides a computer program product including instructions, the instructions, when executed on a computer, causing the computer to perform the multi-field coupled LB simulation method for heat and mass transfer flow in Example 1: S1, acquiring initial parameters for a target water body; S2, importing the initial parameters into a pre-set multi-field coupled LB model of heat and mass transfer flow to perform a simulation operation to obtain flow velocity distribution information, temperature distribution information, and pollutant concentration distribution information about the target water body, where the multi-field coupled LB model is obtained by combining a total energy distribution LB model with a passive scalar model by an introduced set force term to realize bidirectional coupling of a flow field, a temperature field, and a concentration field; and S3, obtaining, according to the flow velocity distribution information, the temperature distribution information, and the pollutant concentration distribution information, spatial distribution results of a flow field, temperature field, and concentration field of the target water body. The computer may be a general-purpose computer, a special-purpose computer, a computer network, or other programmable system.

Finally, it should be noted that the above description is of preferred examples of the present invention and is not intended to limit the scope of the present invention. Thus, it is intended that the present invention cover the modifications and variations of this invention provided they come within the scope of the appended claims and their equivalents.

What is claimed is:

1. A multi-field coupled Lattice Boltzmann (LB) simulation method for heat and mass transfer flow, comprising:
acquiring initial parameters for a target water body;
importing the initial parameters into a pre-set multi-field coupled LB model of heat and mass transfer flow to perform a simulation operation to obtain flow velocity distribution information, temperature distribution information, and pollutant concentration distribution information about the target water body, wherein the multi-field coupled LB model is obtained by combining a total energy distribution LB model with a passive scalar model by an introduced set force term to realize bidirectional coupling of a flow field, a temperature field, and a concentration field; and
obtaining, according to the flow velocity distribution information, the temperature distribution information, and the pollutant concentration distribution information, spatial distribution results of a flow field, temperature field, and concentration field of the target water body.

2. The multi-field coupled LB simulation method for heat and mass transfer flow according to claim 1, wherein the multi-field coupled LB model is
$${f}_{i} ( x + c {δ}_{t} , t + {δ}_{t} ) = {f}_{i} ( x , t ) - \frac{1}{{τ}_{e}} [ {f}_{i} ( x , t ) - {f}_{i}^{eq} ( ρ , u ) ] + {δ}_{i} {F}_{i} ( i = 0 , 1 , … 18 ) , \\ {g}_{i} ( x + c {δ}_{t} , t + {δ}_{t} ) - {g}_{i} ( x , t ) = - \frac{1}{{τ}_{γ}} [ {g}_{i} ( x , t ) - {g}_{i}^{( eq )} ( x , t ) ] ( i = 1 , 2 , … 6 ) , \\ {h}_{i} ( x + c {δ}_{t} , t + {δ}_{t} ) - {h}_{i} ( x , t ) = - \frac{1}{{τ}_{C}} [ {h}_{i} ( x , t ) - {h}_{i}^{( eq )} ( x , t ) ] ( i = 1 , 2 , … 6 ) , \\ {F}_{i} = \frac{1}{2} ( {j}_{i} ( x , t ) + {j}_{i} ( x + {e}_{i} {δ}_{t} , i + {δ}_{t} ) ) , \\ {j}_{t} = {ω}_{i} \{ A - 3 B \cdot [ ( {e}_{t} - u ) + 3 ( {e}_{i} \cdot u ) {e}_{i} ] \} , \\ {f}_{i}^{( eq )} = {ω}_{i} ρ [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] , \\ {g}_{i}^{( eq )} = {ω}_{i} {p}_{α} [ \frac{{c}_{i} \cdot u}{{c}_{s}^{2}} + \frac{{( {c}_{i} \cdot u )}^{2}}{2 {c}_{s}^{4}} - \frac{{u}^{2}}{{c}_{s}^{2}} + \frac{1}{2} ( \frac{{c}_{i}}{{c}_{s}^{2}} - D ) ] + {Ef}_{i}^{( eq )} , \\ {h}_{i}^{( eq )} = {ω}_{i} C [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] ,$$
wherein f represents a flow velocity distribution function; g represents a temperature distribution function obtained according to a total energy distribution LB model; h represents a concentration distribution function obtained according to a passive scalar model; F represents a force term function; i represents a direction parameter; f^{(eq)} represents a flow velocity equilibrium distribution function; g^{(eq)} represents a temperature equilibrium distribution function; h^{(eq)} represents a concentration equilibrium distribution function; x represents a vector position parameter; c represents a unit velocity parameter; cₛ represents a lattice velocity; δₜ represents a unit time parameter; t is a time parameter; u represents a water flow velocity parameter; ω represents a calculation weight coefficient; τ represents a relaxation time parameter; e represents a format velocity parameter; ρ represents a water body density parameter; p represents a pressure parameter; A represents a source term or a sink term in a continuous equation; B represents a source term or a sink term in a momentum equation; for the heat and mass transfer flow characteristics of a reservoir, setting A=0, B=−g[β_{T}(T−T₀)+β_{C}(C−C₀)], β_{c} represents a thermal expansion coefficient; BT represents a solute volume expansion coefficient; C represents a pollution concentration; C₀ represents a reference concentration; D represents a spatial dimension; E represents a set total energy; T represents a water body temperature; T₀ represents a reference temperature.

3. The multi-field coupled LB simulation method for heat and mass transfer flow according to claim 2, wherein the initial parameters comprise the vector position parameter, the unit velocity parameter, the unit time parameter, the water flow velocity parameter, the calculation weight coefficient, the relaxation time parameter, the format velocity parameter, the water body density parameter, the pressure parameter, the thermal expansion coefficient, the solute volume expansion coefficient, the pollution concentration, the reference concentration, the water body temperature, and the reference temperature.

4. The multi-field coupled LB simulation method for heat and mass transfer flow according to claim 1, wherein the obtaining, according to the flow velocity distribution information, the temperature distribution information, and the pollutant concentration distribution information, spatial distribution results of a flow field, temperature field, and concentration field of the target water body comprises: constructing, according to the flow velocity distribution information, the temperature distribution information, and the pollutant concentration distribution information, a three-dimensional spatial distribution map of the flow field, the temperature field, and the concentration field of the target water body.

5. The multi-field coupled LB simulation method for heat and mass transfer flow according to claim 4, wherein the constructing, according to the flow velocity distribution information, the temperature distribution information, and the pollutant concentration distribution information, a three-dimensional spatial distribution map of the flow field, the temperature field, and the concentration field of the target water body comprises: importing the flow velocity distribution information, the temperature distribution information, and the pollutant concentration distribution information into a preset Tecplot software to construct the three-dimensional spatial distribution map of the flow field, the temperature field, and the concentration field of the target water body.

6. The multi-field coupled LB simulation method for heat and mass transfer flow according to claim 1, further comprising: acquiring a construction instruction, constructing the multi-field coupled LB model of heat and mass transfer flow according to the construction instruction, and pre-storing the multi-field coupled LB model.

7. A multi-field coupled Lattice Boltzmann (LB) simulation system for heat and mass transfer flow, comprising an acquisition unit, a simulation unit, and an output unit, wherein the acquisition unit is configured to acquire initial parameters for a target water body;
the simulation unit is configured to import the initial parameters into a pre-set multi-field coupled LB model of heat and mass transfer flow to perform a simulation operation to obtain flow velocity distribution information, temperature distribution information, and pollutant concentration distribution information about the target water body, wherein the multi-field coupled LB model is obtained by combining a total energy distribution LB model with a passive scalar model by an introduced set force term to realize bidirectional coupling of a flow field, a temperature field, and a concentration field; and
the output unit is configured to obtain, according to the flow velocity distribution information, the temperature distribution information, and the pollutant concentration distribution information, spatial distribution results of a flow field, temperature field, and concentration field of the target water body.

8. The multi-field coupled LB simulation system for heat and mass transfer flow according to claim 7, further comprising a construction unit, wherein the construction unit is configured to acquire a construction instruction, construct the multi-field coupled LB model of heat and mass transfer flow according to the construction instruction, and pre-store the multi-field coupled LB model.

9. A multi-field coupled Lattice Boltzmann (LB) simulation system for heat and mass transfer flow, comprising:
a memory, configured to store instructions; and
a processor, configured to read the instructions stored in the memory and perform the method according to claim 1 according to the instructions.

10. A computer-readable storage medium storing thereon instructions, the instructions, when executed on a computer, causing the computer to perform the method according to claim 1.

11. A multi-field coupled Lattice Boltzmann (LB) simulation system for heat and mass transfer flow, comprising:
a memory, configured to store instructions; and
a processor, configured to read the instructions stored in the memory and perform the method according to claim 2 according to the instructions.

12. A multi-field coupled Lattice Boltzmann (LB) simulation system for heat and mass transfer flow, comprising:
a memory, configured to store instructions; and
a processor, configured to read the instructions stored in the memory and perform the method according to claim 3 according to the instructions.

13. A multi-field coupled Lattice Boltzmann (LB) simulation system for heat and mass transfer flow, comprising:
a memory, configured to store instructions; and
a processor, configured to read the instructions stored in the memory and perform the method according to claim 4 according to the instructions.

14. A multi-field coupled Lattice Boltzmann (LB) simulation system for heat and mass transfer flow, comprising:
a memory, configured to store instructions; and
a processor, configured to read the instructions stored in the memory and perform the method according to claim 5 according to the instructions.

15. A multi-field coupled Lattice Boltzmann (LB) simulation system for heat and mass transfer flow, comprising:
a memory, configured to store instructions; and
a processor, configured to read the instructions stored in the memory and perform the method according to claim 6 according to the instructions.

16. A computer-readable storage medium storing thereon instructions, the instructions, when executed on a computer, causing the computer to perform the method according to claim 2.

17. A computer-readable storage medium storing thereon instructions, the instructions, when executed on a computer, causing the computer to perform the method according to claim 3.

18. A computer-readable storage medium storing thereon instructions, the instructions, when executed on a computer, causing the computer to perform the method according to claim 4.

19. A computer-readable storage medium storing thereon instructions, the instructions, when executed on a computer, causing the computer to perform the method according to claim 5.

20. A computer-readable storage medium storing thereon instructions, the instructions, when executed on a computer, causing the computer to perform the method according to claim 6.
